(19) United States
(12) Patent Application Publication
(10) Pub. No.: US 2018/0287450 A1
(43) Pub. Date: Oct. 4, 2018

(54) ELECTRO-MECHANICAL ROTARY ACTUATOR

(71) Applicants: Don Alfano, Roscoe, IL (US); Tony Giannetto, Centereach, NY (US)

(72) Inventors: Don Alfano, Roscoe, IL (US); Tony Giannetto, Centereach, NY (US)

(21) Appl. No.: 15/897,251

(22) Filed: Feb. 15, 2018

Related U.S. Application Data
(60) Provisional application No. 62/471,837, filed on Mar. 15, 2017.

(51) Int. Cl. H02K 5/10; H02K 11/215; H02K 5/132; H02K 51/00

(52) U.S. Cl. CPC H02K 5/10; H02K 11/215; H02K 2205/09; H02K 51/00; H02K 5/132

(57) ABSTRACT

A rotary actuator is provided. The rotary actuator includes a plurality of housings and a motor supported within one of the housings. The motor includes a rotatable motor output shaft. The rotatable motor output shaft is centered about a first longitudinal axis. A gear package is configured to engage the motor output shaft of the motor such that rotation of the motor output shaft results in rotation of portions of the gear package. An actuator output shaft is configured to engage the gear package such that rotation of portions of the gear package results in rotation of the actuator output shaft. The actuator output shaft is centered about a second longitudinal axis. The first longitudinal axis is offset from the second longitudinal axis.

### CROSS-REFERENCE TO RELATED APPLICATIONS

This application claims the benefit of U.S. Provisional Application No. 62/471,837, filed Mar. 15, 2017, the disclosure of which is incorporated herein by reference.

### BACKGROUND

This invention relates in general to electro-mechanical rotary actuators adapted to cause rotational movement of an output shaft. In particular, this invention relates to an improved electro-mechanical rotary actuator that is relatively compact in size, substantially waterproof, and inexpensive.

A typical electro-mechanical rotary actuator includes a motor that has a rotatable motor output shaft. The output shaft of the motor can be connected through a geared arrangement to an actuator output shaft. The direction of the rotational movement of the output shaft depends on the rotational direction of the motor output shaft, as well as the gearing arrangement used in connecting the motor output shaft with the actuator output shaft.

Electro-mechanical rotary actuators are widely used in a variety of applications, ranging from small to large loads. To meet the task at hand, electro-mechanical rotary actuators come in all sizes; generally with larger, heavier electro-mechanical rotary actuators handling large loads, and smaller, lighter electro-mechanical rotary actuators handling small loads.

Regardless of their size, electro-mechanical rotary actuators can include feedback systems, thereby enabling more precise output control. Conventional feedback systems can use various sensors and sensor systems, including Hall-Effect sensor systems. Due to the size and physical arrangement of the component parts, conventional feedback systems can require a housing having an increased volumetric size, resulting in the electro-mechanical rotary actuator requiring a large footprint.

Electro-mechanical rotary actuators are used for many different applications, some of which result in the exposure of the actuator to water. The introduction of water to the components inside the housing of the electro-mechanical rotary actuator can result in reduced performance and eventual equipment failure.

It would be desirable to provide an improved electro-mechanical rotary actuator with an improved feedback system, an improved housing with enhanced hermetic properties, all while reducing the overall actuator footprint.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the electro-mechanical rotary actuator.

The above objects as well as other objects not specifically enumerated are achieved by a rotary actuator. The rotary actuator includes a plurality of housings and a motor supported within one of the housings. The motor includes a rotatable motor output shaft. The rotatable motor output shaft is centered about a first longitudinal axis. A gear package is configured to engage the motor output shaft of the motor such that rotation of the motor output shaft results in rotation of portions of the gear package. An actuator output shaft is configured to engage the gear package such that rotation of portions of the gear package results in rotation of the actuator output shaft. The actuator output shaft is centered about a second longitudinal axis. The first longitudinal axis is offset from the second longitudinal axis.

The above objects as well as other objects not specifically enumerated are also achieved by a rotary actuator. The rotary actuator includes a plurality of housings and a motor supported within the housings. The motor includes a rotatable motor output shaft. A gear package is configured to engage the motor output shaft of the motor such that rotation of the motor output shaft results in rotation of portions of the gear package. An actuator output shaft is configured to engage the gear package such that rotation of portions of the gear package results in rotation of the actuator output shaft. A feedback system includes a feedback shaft. The feedback shaft extends in a direction opposite the actuator output shaft and is configured to rotate as the actuator output shaft rotates.

The above objects as well as other objects not specifically enumerated are also achieved by a rotary actuator. The rotary actuator includes a plurality of housings forming a length. A motor is supported within one of the housings and includes a rotatable motor output shaft. A gear package is configured to engage the motor output shaft of the motor such that rotation of the motor output shaft results in rotation of portions of the gear package. An actuator output shaft is configured to engage the gear package such that rotation of portions of the gear package results in rotation of the actuator output shaft. The length of the plurality of housing is in a range of from about 4.5 inches to about 7.5 inches.

Various aspects of the electro-mechanical rotary actuator will become apparent to those skilled in the art from the following detailed description of the illustrated embodiments, when read in light of the accompanying drawings.

### BRIEF DESCRIPTION OF THE DRAWINGS

FIG. 1 is a perspective view of an electro-mechanical rotary actuator.

FIG. 2 is an exploded perspective view of a portion of the electro-mechanical rotary actuator of FIG. 1.

FIG. 3 is an exploded perspective view of a portion of the electro-mechanical rotary actuator of FIG. 1.

FIG. 4 is an exploded perspective view of a portion of the electro-mechanical rotary actuator of FIG. 1.

FIG. 5 is a partial cross-sectional view of a portion of the electro-mechanical rotary actuator of FIG. 1, illustrating a feedback shaft.

FIG. 6 is a perspective view of a feedback system of the electro-mechanical rotary actuator of FIG. 1.

FIG. 7 is a side view of the electro-mechanical rotary actuator of FIG. 1, illustrating placement of the electro-mechanical rotary actuator in a fluid flow.

### DETAILED DESCRIPTION

The electro-mechanical rotary actuator (hereafter “rotary actuator”) will now be described with occasional reference to specific embodiments. The rotary actuator may, however, be embodied in different forms and should not be construed as limited to the embodiments set forth herein. Rather, these embodiments are provided so that this disclosure will be thorough and complete, and will fully convey the scope of the rotary actuator to those skilled in the art.

Unless otherwise defined, all technical and scientific terms used herein have the same meaning as commonly understood by one of ordinary skill in the art to which the rotary actuator belongs. The terminology used in the description of the rotary actuator is for describing particular embodiments only, and is not intended to be limiting of the rotary actuator. As used in the description of the rotary actuator and the appended claims, the singular forms “a,” “an,” and “the” are intended to include the plural forms as well, unless the context clearly indicates otherwise.

Unless otherwise indicated, all numbers expressing quantities of dimensions such as length, width, height, and so forth as used in the specification and claims are to be understood as being modified in all instances by the term “about.” Accordingly, unless otherwise indicated, the numerical properties set forth in the specification and claims are approximations that may vary depending on the desired properties sought to be obtained in the embodiments of the rotary actuator. Notwithstanding that the numerical ranges and parameters setting forth the broad scope of the rotary actuator are approximations, the numerical values set forth in the specific examples are reported as precisely as possible. Any numerical values, however, inherently contain certain errors necessarily resulting from errors found in their respective measurements.

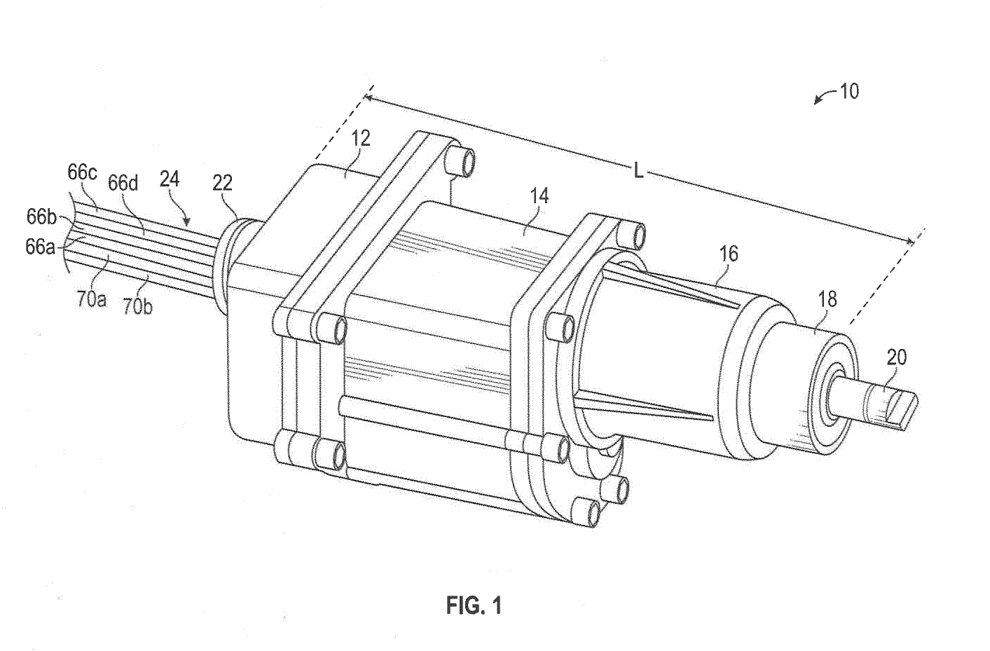

Referring now to the figures there is illustrated in FIG. 1 a rotary actuator 10. Generally, the rotary actuator 10 is configured for use in applications where space is limited, water conditions are present and a cost effective solution is desired. The rotary actuator 10 is configured to receive an electrical current input and provide a rotational movement output.

Referring again to FIG. 1, the rotary actuator 10 includes a plurality of housings, each of which is configured to define one or more internal regions. The rotary actuator 10 includes a motor housing cover 12, a motor housing 14, a gear housing 16, and an output housing 18. The housings 12, 14, 16, 18 are configured to protect various internal components and assemblies from external conditions, such that the rotary actuator 10 is substantially water resistant when the rotary actuator is displaced in one of a fluid flow and/or a body of water. In operation, the rotary actuator 10 can be submerged under at least 12.0 inches of water, and can experience maximum water pressures of 50.0 pounds per square inch (psi) within a fluid flow. The housings 12, 14, 16, 18 are further configured to support various internal components as will be explained in more detail below.

Referring again to FIG. 1, the rotary actuator 10 also includes an output shaft 20, a multi-wire coupler 22 and a wire grouping 24, all of which will be discussed in detail below.

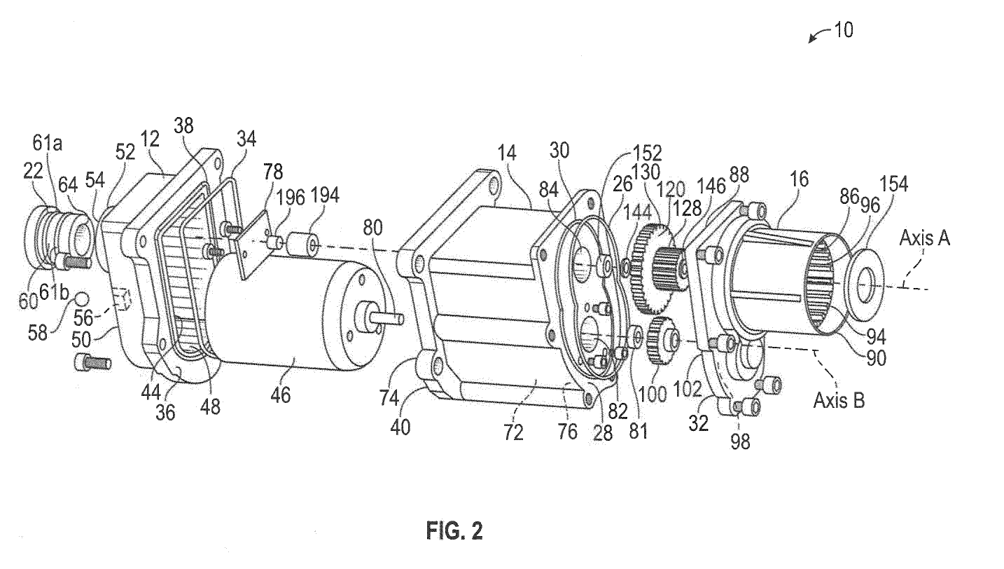

Referring now to FIGS. 2-4, the rotary actuator 10 is shown in a disassembled arrangement. The gear housing 16 is coupled to the motor housing 14 via a plurality of fasteners. The motor housing 14 is further coupled to the motor housing cover 12 via a second plurality of fasteners. The output housing 18 is connected to the gear housing 16 with a threaded fit. However, it will be appreciated that in other embodiments, the housings 12, 14, 16, 18 can be attached together with other structures, mechanisms, devices and methods.

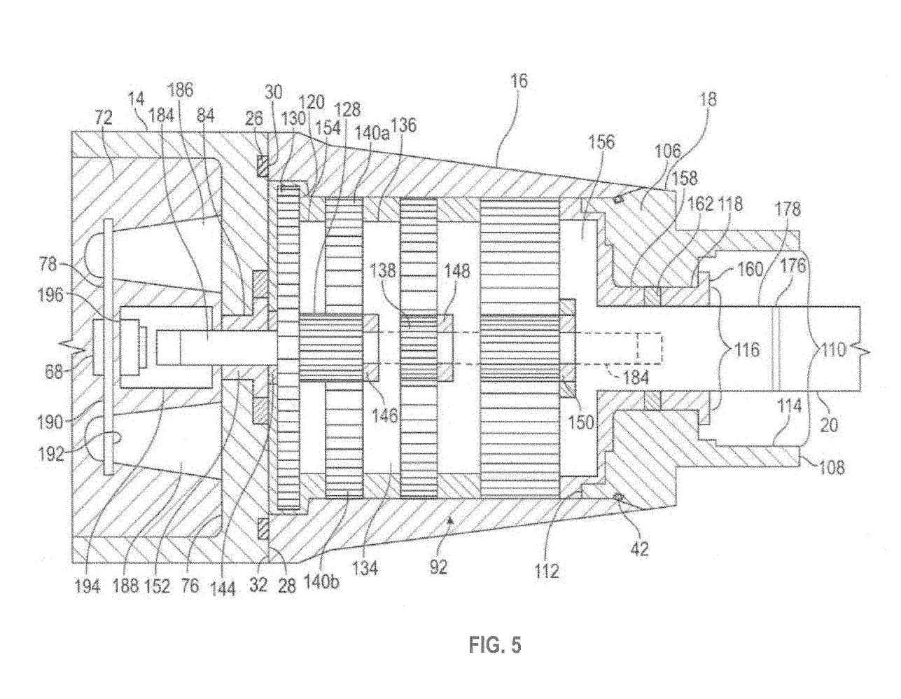

Referring now to FIGS. 2 and 5, a first gasket 26 is disposed between the motor housing 14 and the gear housing 16. The first gasket 26 is configured to provide a substantially waterproof seal between the motor housing 14 and the gear housing 16. The first gasket 26 may be made out of a polymeric material, or a combination of polymeric materials, with compression features, such as the non-limiting examples of polyurethane or polypropylene. However, it will be appreciated that the first gasket 26 can be made out of any suitable material, or combinations of materials, sufficient to provide a substantially waterproof seal between the motor housing 14 and the gear housing 16.

Referring again to FIGS. 2 and 5, the motor housing 14 includes a first face 28 having a recess 30 formed therein. The recess 30 is configured to receive a portion of the first gasket 26. The recess 30 is disposed along a substantially distal perimeter of the first face 28 of the motor housing 14. When assembled, the first face 28 engages a second face 32 of the gear housing 16, thereby compressing the first gasket 26 between the faces 28 and 32, such as to form a substantially waterproof seal. In other embodiments, the rotary actuator 10 can have other mechanisms, structures, or devices sufficient to provide a substantially waterproof seal between the motor housing 14 and the gear housing 16.

Referring now to FIG. 2, a second gasket 34 is disposed between the motor housing 14 and the motor housing cover 12. The second gasket 34 is configured to provide a substantially waterproof seal between the motor housing 14 and the motor housing cover 12. In the illustrated embodiment, the second gasket 34 is made out of the same polymeric materials as the first gasket 26. However, it will be appreciated that the second gasket 34 can be made out any suitable material, or combinations of materials, sufficient to provide a substantially waterproof seal between the motor housing 14 and the motor housing cover 12.

Referring again to FIG. 2, the motor housing cover 12 includes a third face 36 having a recess 38 formed therein. The recess 38 is configured to receive a portion of the second gasket 34. The recess 38 is disposed along a substantially distal perimeter of the third face 36. When assembled, the third face 36 of the motor housing cover 12 engages a fourth face 40 of the motor housing 14, thereby compressing the second gasket 34 between the faces 36 and 40, such as to form a substantially waterproof seal. In other embodiments, the rotary actuator 10 can have other mechanisms, structures, or devices sufficient to provide a substantially waterproof seal between the motor housing cover 12 and the motor housing 14.

Referring now to FIGS. 2 and 4-5, a third gasket 42 is disposed between the output housing 18 and the gear housing 16. The third gasket 42 is configured to provide a substantially waterproof seal between the output housing 18 and the gear housing 16. In the illustrated embodiment, the third gasket 42 is made out of the same polymeric materials as the first and second gaskets 26, 34. However, it will be appreciated that the third gasket 42 can be made out of any suitable materials, or combination of materials, sufficient to provide a substantially waterproof seal between the output housing 18 and the gear housing 16.

Referring again to FIGS. 2 and 4-5, when assembled, the gear housing 16 engages the output housing 18, thereby compressing the third gasket 42 between the gear housing 16 and the output housing 18, such as to form a substantially waterproof seal. In other embodiments, the rotary actuator 10 can have other mechanisms, structures, or devices sufficient to provide a substantially waterproof seal between the output housing 18 and the gear housing 16.

Referring now to FIG. 2, the motor housing cover 12 includes a cavity 44 formed therein. The cavity 44 is configured to receive a portion of a motor 46, a portion of the multi-wire coupler 22 and the wire grouping 24 (not shown in FIG. 2 for purposes of clarity, see FIG. 1). The cavity 44 extends from an opening 48, formed within the first face 36 of the motor housing cover 12, and is bounded by a rear wall 50. The motor housing 12 also includes a protrusion 52 extending from the rear wall 50 and opposite the cavity 44, with a cavity 54 formed therethrough. The cavity 54 is configured to receive a portion of the multi-wire coupler 22. The motor housing 12 further includes a test port 56 formed within the rear wall 50. The test port 56 is configured to facilitate pressure testing of the internal regions of the assembled housings 12, 14, 16, 18 and multi-wire coupler 22. A ball 58 can be disposed in the test port 56 and can be configured to plug the test port 56 after testing to provide a substantially waterproof seal between the test port 56 and the rear wall 50.

Referring again to FIG. 2, the multi-wire coupler 22 is positioned within the cavity 54. Redundant O-rings 61a, 61b are disposed on an outer circumference 60 of the multi-wire coupler 22. When assembled, the outer circumference 60 of the multi-wire coupler 22 engages the inner circumferential wall (not shown) of cavity 54, thereby compressing the redundant O-rings 61a, 61b, such as to provide a substantially waterproof seal between the multi-wire coupler 22 and the motor housing cover 12. A retaining ring (not shown) engages the outer circumference 60 of the multi-wire coupler 22 to axially retain the multi-wire coupler 22 within the cavity 54.

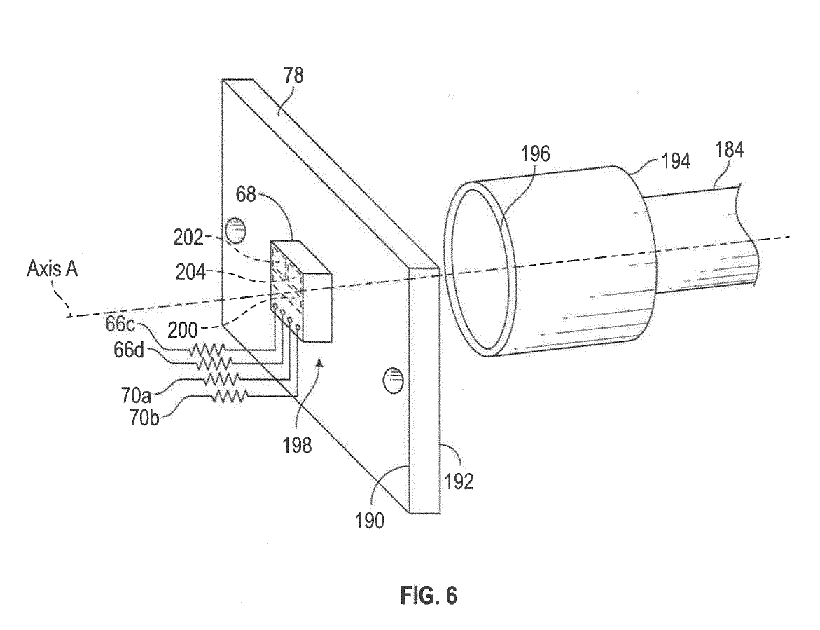

Referring now to FIGS. 1-2, the multi-wire coupler 22 includes a cavity 64 formed therethrough that is configured to receive the wire grouping 24. The wire grouping 24 includes a plurality of power wires 66a-66b configured to provide power to the motor 46. The power wires 66c, 66d are configured to provide power to an integrated circuit 68 (see FIGS. 5 and 6). The integrated circuit 68 will be discussed in more detail below.

Referring now to FIG. 1, the wire grouping 24 further includes a first and a second signal output wire 70a, 70b, both of which are configured to transmit feedback signals from the integrated circuit 68 to a diagnostic controller (not shown). In other embodiments, the rotary actuator 10 can have other mechanisms, structures, or devices sufficient to receive and transmit feedback signals to a diagnostic controller, such as the non-limiting example of wireless transmission devices.

Referring again to FIGS. 1-2, an epoxy-polymer based seal material (not shown) is used to affix the wires 66a-66d, 70a, 70b within the cavity 64 of the multi-wire coupler 22 such as to provide a substantially waterproof seal. However, it will be appreciated that the epoxy-polymer based seal material can be any suitable material, or combination of materials, sufficient to affix the wires 66a-66d, 70a, 70b within the cavity 64 of the multi-wire coupler 22 and provide a substantially waterproof seal.

Referring now to FIG. 2, the motor housing 14 includes a cavity 72 formed therein. The cavity 72 extends from an opening 74, formed within the fourth face 40 of the motor housing 14, and is bounded by an inside wall 76 of the first face 28. The cavity 72 is configured to receive a portion of the motor 46 and a circuit board 78. The motor 46 is configured to provide torque to a rotatable motor shaft 80. The motor housing 14 further includes a motor shaft opening 82 and a feedback shaft opening 84, both disposed through the first face 28 and the inside wall 76. The motor shaft 80 extends through a bushing 81 disposed within the motor shaft opening 82. The circuit board 78 and the feedback shaft opening 84 will be further discussed below.

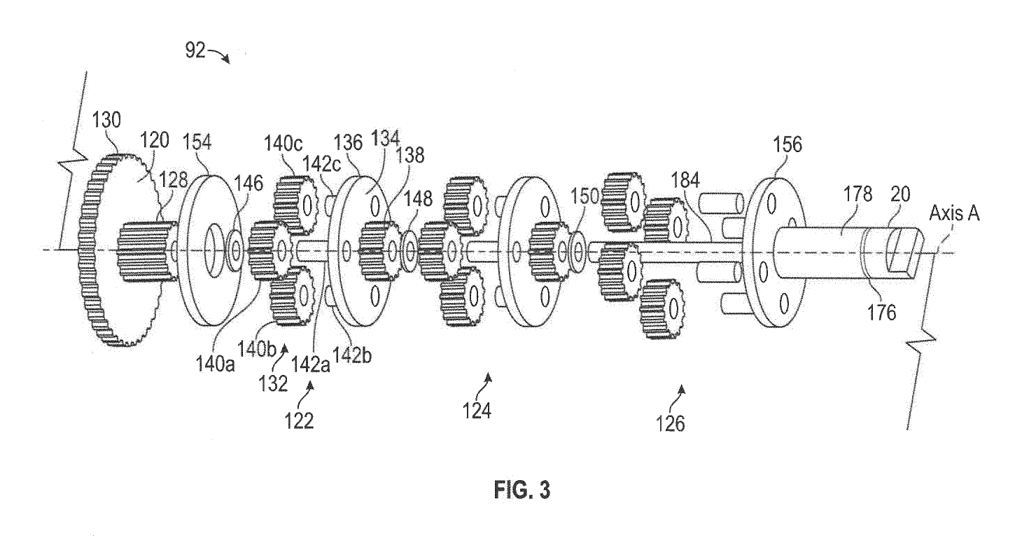

Referring again to FIG. 2, the gear housing 16 includes a first cavity 86 extending from an opening 88, formed within the second face 32, through an opposing side 90 of the gear housing 16. The first cavity 86 is configured to receive a planetary gear reduction package 92 (hereafter “gear package) (as shown in FIG. 3). The first cavity 86 is further defined by an internal circumferential wall 94. The internal circumferential wall 94 includes a plurality of spaced apart gear teeth 96, which are broached into the gear housing 16 for cost effectiveness. The gear teeth 96 are configured to engage individual planetary gears included in the gear package 92 (also shown in FIG. 3), which will be further discussed below.

Referring again to FIG. 2, the gear housing 16 additionally includes a second cavity 98 configured to receive a pinion gear 100. The second cavity 98 extends inwardly from an opening 102 formed within the second face 32. The pinion gear 100 is mounted on the motor shaft 80 and is configured to engage the gear package 92 (shown in FIG. 3). The pinion gear 100 is configured to rotate in accordance to the torque of the motor shaft 80, which is created by the operation of the motor 46. A portion of the second cavity 98 overlaps the first cavity 86, such as to permit the pinion gear 100 to engage the gear package 92.

Referring now to FIGS. 1-2, the motor shaft 80 and the output shaft 20 are configured in a substantially parallel offset arrangement, more specifically the motor shaft 80 is disposed about Axis B, while the output shaft 20 is disposed about Axis A; with Axis A being substantially in parallel to Axis B. This substantially parallel arrangement permits the rotary actuator 10 to have a short overall length L, sufficient for placement within a compact compartment to suit unique customer envelopes. In the illustrated embodiment, the length L is in a range of from about 4.5 inches to about 7.5 inches. However, in other embodiments, the length L can be less than about 4.5 inches or more than about 7.5 inches, sufficient for placement within a compact compartment. Advantageously, the length L achieved by the substantially parallel arrangement of the motor shaft 80 and the output shaft 20 is generally shorter than a conventional rotary actuator with an arrangement of a motor shaft and an output shaft on a shared axis.

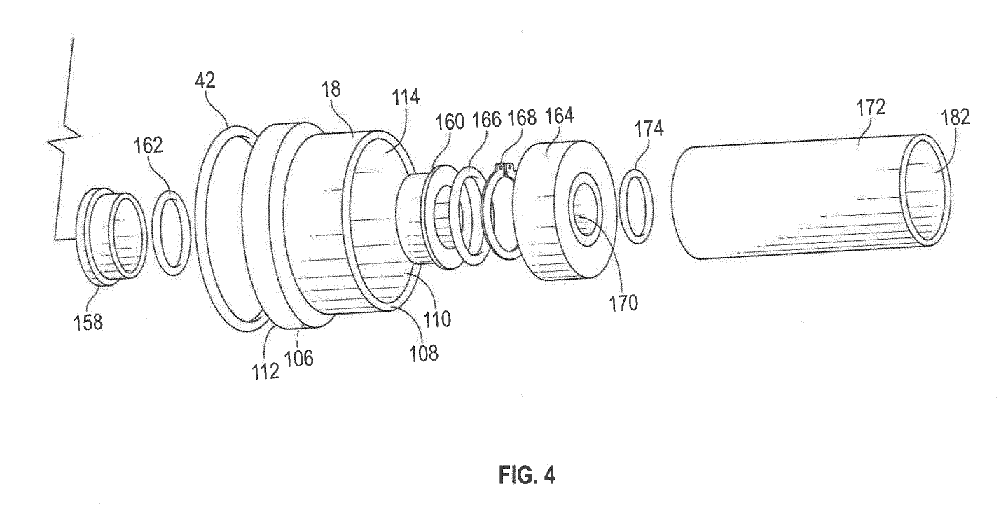

Referring now to FIGS. 4 and 5, the output housing 18 is bounded by a first end 108 and a second end 112. The output housing 18 includes a first cavity 110 and a second cavity 116, both formed therein. The first cavity 110 and the second cavity 116 are configured to receive the output shaft 20, which passes therethrough. The first cavity 110 extends inwardly from a first end 108 and is radially bounded by a wall 106. The first cavity 110 is internally defined by a first circumferential wall 114. The first cavity 110 is further configured to seat the output shaft seal 164. The second cavity 116 extends axially to the wall 106. The second cavity 116 is further defined by a second circumferential wall 118. The second cavity 116 will be further discussed below.

Referring now to FIGS. 3 and 5, the gear package 92 is illustrated. The gear package 92 is configured to increase the torque, while reducing the rotational speed of the output shaft 20, more specifically the gear package 92 is configured to limit the rotation range of the output shaft 20 to one revolution. The motor controller (not shown) is configured to control the rotation of the output shaft 20 by controlling the rotation of the motor shaft 80. The gear package 92 includes a cluster gear 120, a first gear arrangement 122, a second gear arrangement 124, and a third gear arrangement 126, positioned in a nested configuration. The structure of the first, second and third gear arrangements 122, 124, 126 forming the gear package 92 is configured to provide the required torque and rotational speed characteristics, while constrained to the overall reduced overall length L of the rotary actuator 10.

Referring now to FIGS. 2, 3 and 5, the cluster gear 120 includes a sun gear 128 connected to a drive gear 130, such that rotation of the drive gear 130 results in rotation of the sun gear 128. The drive gear 130 is configured to engage the pinion gear 100, which is mounted to the motor shaft 80.

The first gear arrangement 122 includes a planetary gear arrangement 132, and a torque transfer assembly 134. The torque assembly 134 includes a carrier 136 that is connected to a sun gear 138, such that rotation of the carrier 136 results in rotation of the sun gear 138. The carrier 136 has a larger circumference than the sun gear 138, thereby resulting in a desired torque increase. The planetary gear arrangement 132 includes planetary gears 140a-140c, which are connected to the carrier 136 via gear axles 142a-142c. The planetary gears 140a-140c are configured to engage the sun gear 128 of the cluster gear 120 and the gear teeth 96, which are disposed in the gear housing 16 as discussed above. As illustrated in FIG. 3, the planetary arrangement 132 includes three planetary gears 140a-140c; however, it will be appreciated that any number of planetary gears could be used in the planetary arrangement 132.

Referring now to FIGS. 3 and 5, the second gear arrangement 124 and the third gear arrangement 126 are illustrated. The second gear arrangement 124 and the third gear arrangement 126 are substantially similar to the first gear arrangement 122, thus the second and third gear arrangements 124, 126 will not be individually described. However, it will be appreciated that the second gear arrangement 124 and the third gear arrangement 126 may differ from the first gear arrangement 122, and differ in comparison with each other. For example, as illustrated the third gear arrangement 126 includes four planetary gears, while the first gear arrangement 122 and second gear arrangement 124 include three planetary gears.

It will also be appreciated that although only three gear arrangements 122, 124, 126 are illustrated, any number of gear arrangements may be used sufficient to provide the desired function torque and rotational speed characteristics. It will also be appreciated that although the gear package 92 is illustrated as supporting the individual planetary gears with planetary gear axles, the gear package 92 can have other mechanisms, structures or devices sufficient to support the individual planetary gears. Additionally, while the gear arrangements 122, 124, 126 are designed to meet load/life requirements by using an aluminum material, in other embodiments the gear arrangements 122, 124, 126 can be made of any material, or combination of materials, sufficient to meet the requirements described herein.

Referring now to FIGS. 2, 3 and 5, spacers 144, 146, 148, 150 are configured to provide substantially frictionless structures between adjacent rotating parts to facilitate rotational movement. Spacer 144 is disposed between a bushing 152 and the cluster gear 120. The bushing 152 is received within the feedback shaft opening 84 of the first face 28 of the motor housing 14 and is configured to support the feedback shaft 184. Spacer 146 is disposed between the sun gear 128 and the carrier 136. Spacer 148 is disposed between the first gear arrangement 122 and the second gear arrangement 124. Finally, spacer 150 is disposed between the second gear arrangement 124 and a carrier 156.

Referring again to FIGS. 2-3 and 5, a spacer 154 is disposed between the cluster gear 120 and the planetary gears 140a-140c of the planetary gear arrangement 132. The spacer 154 is configured to support the planetary arrangement 132 and provide a substantially frictionless structure between the cluster gear 120 and the planet gears 140a-140c to facilitate rotational motion.

Referring now to FIGS. 3-5, the output shaft 20 forms a unitary body with the carrier 156 of the third gear arrangement 126, such that rotation of the carrier 156 results in rotation of the output shaft 20. While in the illustrated embodiment the output shaft 20 and the carrier 156 are shown as a unitary body, it will be appreciated that in other embodiments the output shaft 20 and the carrier 156 can be discrete components that are attached together. In still other embodiments, the output shaft 20 and the carrier 156 can be other mechanisms, structures, or devices sufficient to transmit rotational movement. It will also be appreciated that although in the illustrated embodiment the output shaft 20 extends from the carrier 156, the output shaft 20 may extend from any gear arrangement sufficient to provide the desired function of transferring rotation from the gear package 92 to an output structure.

Referring now to FIGS. 4-5, the output shaft 20 extends from the carrier 156 of the third gear arrangement 126 through bushings 158, 160, a shaft seal 162, cavity 110 and cavity 116. The bushings 158, 160 are disposed within the cavity 116, included in the output housing 18. The bushings 158, 160 are configured to support the output shaft 20 for rotation in both axial and radial directions. The shaft seal 162 is disposed between bushing 158 and bushing 160, within cavity 116. The shaft seal 162 is a dynamic seal and is configured to provide a substantially waterproof seal between the output shaft 20 and the second circumferential wall 118 of cavity 116. The shaft seal 162 acts as a redundant seal to an output seal member 164, which will be discussed below. In the illustrated embodiment, the shaft seal 162 is formed from a Buna-N rubber-based material, or a combination of Buna-N rubber-based materials, with compression features. However, it will be appreciated that the shaft seal 162 can be formed from other suitable materials, or combination of materials, sufficient to provide a substantially waterproof seal between the output shaft 20 and the second circumferential wall 118 of the output housing 18.

Referring again to FIGS. 3-5, when the output shaft 20 is assembled through cavity 116, the shaft seal 162 compresses, providing a substantially waterproof seal between the output shaft 20 and the second circumferential wall 118 of the cavity 116. However, it should be appreciated that in other embodiments, the rotary actuator 10 can have other mechanisms, structures, or devices sufficient to provide a substantially waterproof seal between the output shaft 20 and the output housing 18.

Referring now to FIGS. 4 and 5, the output seal member 164, a spacer 166, and a retaining ring 168 are configured to be positioned within cavity 110 of the output housing 18. The output sealing member 164 includes a cavity 170 sized to receive the output shaft 20 extending therethrough. The output sealing member 164 is configured to engage the first circumferential wall 114 of the cavity 110 and the output shaft 20 to provide a substantially waterproof seal therebetween. In the illustrated embodiment, the output sealing member 164 is a seal formed with a plurality of sealing lips. However, in other embodiments, the output sealing member 164 can have other forms sufficient to provide a substantially waterproof seal between the output shaft 20 and the output housing 18. It is further contemplated that in other embodiments, the rotary actuator 10 can have other mechanisms, structures, or devices, in lieu of the output sealing member 164, sufficient to provide a substantially waterproof seal between the output shaft 20 and the output housing 18.

Referring again to FIGS. 4-5, the output shaft 20 extends through openings formed within the spacer 166 and the retaining ring 168. The spacer 166 is positioned between the bushing 158 and the retaining ring 168 and is configured to provide a substantially frictionless structure. The retaining ring 168 is positioned between the spacer 166 and the output sealing member 164 and is configured to axially retain the output shaft 20 within the output housing 18.

Referring to FIGS. 3-5, the rotary actuator 10 further includes a coupling member 172 and a retention device 174. The coupling member 172 is configured to connect the output shaft 20 to downstream structures (not shown). The retention device 174 is partially received in a first groove 176 on an outer circumferential surface 178 of the output shaft 20 and a second groove (not shown) on an inner circumferential surface 182 of the coupling member 172. The retention device 174 is configured to compress between the coupling member 172 and the output shaft 20 when assembled, thereby retaining the coupling member 172 to the output shaft 20. In other embodiments, the rotary actuator 10 can have other mechanisms, structures, or devices sufficient to provide a connection between the output shaft 20 and the downstream structures (not shown).

Referring now to FIGS. 3 and 5, a feedback shaft 184 is attached to the output shaft 20, such that rotation of the output shaft 20 results in rotation of the feedback shaft 184. The feedback shaft 184 extends in a direction opposite the output shaft 20, with the feedback shaft 184 and the output shaft 20 having a shared axis A. The structure of the output shaft 20, having direct attachment to the feedback shaft 184, advantageously reduces or substantially eliminates undesirable gear backlash. Additionally, with the rotational range of the output shaft 20 being limited to one revolution by the gear package 92, undesirable gear backlash can be advantageously reduced or substantially eliminated.

Referring now to FIGS. 2, 3 and 5, the spacers 144, 146, 148, 150, the gear arrangements 122, 124, 126 and the cluster gear 120 all include feedback shaft openings formed therethrough. The feedback shaft 184 extends through the feedback shaft openings formed through the spacers 144, 146, 148, 150, the gear arrangements 122, 124, 126, the cluster gear 120, and finally through the bushing 152 disposed within the feedback shaft opening 84 formed through the first face 28 of the motor housing 14. The feedback shaft 184 has a diameter sized to rotate without interference from the spacers 144, 146, 148, 150 or the gear arrangements 124, 126, while the feedback shaft 184 does engage the cluster gear 120, gear arrangement 122, and the bushing 152 to provide support for cluster gear 120. The feedback shaft 184 further extends into cavity 72, formed within the motor housing 14.

Referring now to FIGS. 5-6, the circuit board 78 is illustrated. The circuit board 78 is fixed to the motor housing 14 by a plurality of bosses 186, 188 connected with a plurality of fasteners (not shown). The bosses 186, 188 extend into the cavity 72 from the inside wall 76 of the first face 28 of the motor housing 14. The circuit board 78 includes a first side 190 and a second side 192. The integrated circuit 68 is disposed on a first side 190 of the circuit board 78. The integrated circuit 68 will be further described below.

Referring to FIGS. 2, 5 and 6, a magnet housing 194 is attached to a distal end of the feedback shaft 184. The magnet housing 194 includes a magnet 196 and is positioned proximate to the second side 192 of the circuit board 78, opposite the integrated circuit 68. With the magnet 196 coupled to the feedback shaft 184, the magnet 196 is configured to rotate at the same rotational speed and direction as the feedback shaft 184.

Referring again to FIG. 6, a feedback system 198 is included on the integrated circuit 68. The feedback system 198 includes a Hall-Effect sensor 200 (hereafter “sensor”), a digital-to-analog converter 202 (hereafter “converter”) and a controller 204. The sensor 200 is configured to detect the position and rotation of the magnet 196 and provide digital position and rotation signals to the converter 202. In the embodiment illustrated in FIG. 6, a center of the integrated circuit 68 and a center of the magnet 196 are co-axially positioned on Axis A. Without being held to the theory, it is believed the co-axial position of the center of the integrated circuit 68 and a center of the magnet 196 provide an optimum detection of the position and rotation of the magnet 196 by the sensor 200. However, it should be appreciated that in other embodiments, the center of the integrated circuit 68 may be disposed anywhere on the circuit board 78 and anywhere in relation to the magnet 196, sufficient to detect the position and rotation of the magnet 196 and provide digital position and rotation signals to the converter 202.

Referring again to FIG. 6, the converter 202 is configured to convert the digital position and rotation signals into analog signals, with the analog signals including a first feedback signal and a redundant feedback signal. The first feedback and redundant feedback signals are output via signal output wires 70a, 70b. The controller 204 is configured to program the converter 202, which is well known in the art. The first feedback and redundant feedback signals may be programmed at assembly to provide the required analog signal at key mechanical positions, such as the non-limiting examples of forward, reverse, and neutral in a standard transmission assembly. In other embodiments, it should be appreciated that the feedback system 198 and integrated circuit 68 can have other mechanisms, structures or devices sufficient to provide position and rotation signals to the diagnostic controller.

Referring now to FIGS. 1 and 6, the integrated circuit 68 is configured to transmit the first feedback and the redundant feedback signals to the diagnostic controller (not shown) via the signal output wires 70a, 70b. The diagnostic controller is configured to receive and compare the first feedback signals and the redundant feedback signals to determine if a difference in the signals is present.

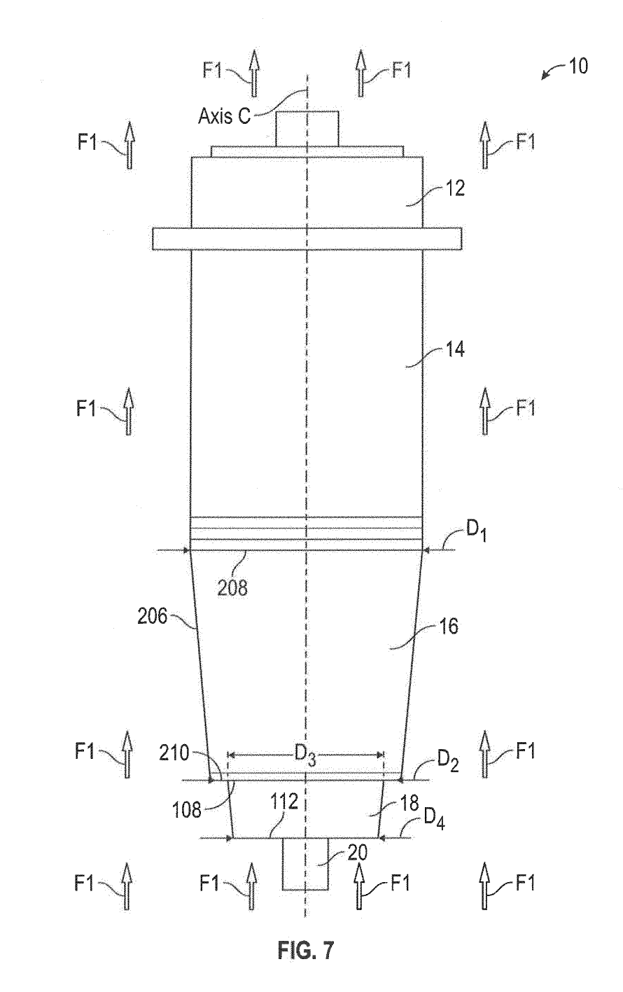

Referring now to FIG. 7, the rotary actuator 10 is illustrated within a fluid flow, as represented by direction arrows F1. As discussed above, the rotary actuator 10 includes the housings 12, 14, 16, 18 and the output shaft 20. It will be appreciated that although in the illustrated embodiment the rotary actuator 10 is displaced within a fluid flow, the rotary actuator 10 could alternatively be displaced within a static body of water. As stated before, the housings 12, 14, 16, 18 are configured such that the rotary actuator 10 is substantially waterproof when displaced in one of a fluid flow and a body of water, up to water pressures of 50 psi. In the illustrated embodiment, the rotary actuator 10 is vertically oriented and radially centered about a longitudinal axis C such that the vertically oriented fluid flow F1 engages the housings 12, 14, 16, 18 in a substantially equal manner. However, in other embodiments the rotary actuator 10 can have other orientations within the fluid flow F1.

Referring again to FIG. 7, the rotary actuator 10 has an overall shape configured to complement the fluid flow F1 such that the fluid flow F1 flows over the rotary actuator 10 with a minimum of resistance. In the illustrated embodiment, the rotary actuator 10 has a conical profile formed by the cooperation of the gear housing 16 and the output housing 18. The conical profile of the gear housing 16 and the output housing 18 is configured to facilitate the fluid flow F1 around the rotary actuator 10. Alternatively, the housings forming the rotary actuator 10 can have other profiles sufficient to facilitate the fluid flow F1 around the rotary actuator 10.

Referring again to FIG. 7, the gear housing 16 includes a cylindrical profile 206. The cylindrical profile 206 includes a first end 208 and a second end 210. The first end has a diameter D₁, while the second end has a diameter D₂. The diameter D₁ of the first end 208 is larger than the diameter D₂ of the second end 210, thus defining the conical profile of the cylindrical profile 206 of the gear housing 16.

Referring again to FIG. 7, the output housing 18 is cylindrical in shape and includes the first end 108 and a second end 112. The first end 108 has a diameter D₃ while the second end 112 has a diameter D₄. The diameter D₃ of the first end 108 is larger than the diameter D₄ of the second end 112, thus defining the conical profile of the output housing 18.

In operation, the rotary actuator 10 may be displaced in one of a fluid flow and a body of water. Advantageously, the substantially waterproof sealing of the housings 12, 14, 16, 18 provide for continuous reliable operation of the rotary actuator 10 in water pressures of 50 psi and submerged in at least 12.0 inches of water.

Referring now to FIGS. 1-7, the operation of the rotary actuator 10 will now be described in the following steps. In a first step, the motor 46 is controlled by the motor controller. The motor 46 urges rotation of the motor shaft 80. In a next step, the motor shaft 80 rotates the pinion gear 100. In a next step, the pinion gear 100 engages the cluster gear 120, which is included in the gear package 92, thereby transferring rotational motion from the pinion gear 100 to the drive gear 130 of the gear package 92. Next, the cluster gear 120 engages the first gear arrangement 122, thereby transferring rotational motion from the cluster gear 120 to the first gear arrangement 122. In a next step, the first gear arrangement 122 engages the second gear arrangement 124, thereby transferring rotational motion from the first gear arrangement 122 to the second gear arrangement 124. Next, the second gear arrangement 124 engages the third gear arrangement 126, thereby transferring rotational motion from the second gear arrangement 124 to the third gear arrangement 126.

Referring again to FIGS. 1-7 and as noted above, the output shaft 20 forms a unitary body with the carrier 156 of the third gear arrangement 126, therefore the output shaft 20 rotates in conjunction with the rotation of the third gear arrangement 126. Also, because the feedback shaft 184 is connected to the output shaft 20, the feedback shaft 184 also rotates in conjunction with the rotation of the third gear arrangement 126.

Referring again to FIGS. 5-6, in a next step, the magnet 196 rotates in conjunction with the rotation of the feedback shaft 184. Next, the rotation and position of the magnet 196 is detected by the sensor 200. The sensor 200 produces rotational and positional signals and sends the signals to the converter 202.

Prior to receiving the rotational and positional signals, the converter 202 is programmed by the controller 204 to assign specific analog values to specific digital position readings sensed by the sensor 200, corresponding to the position of the magnet 196. The programmed analog values may correspond to key mechanical positions, such as the non-limiting examples of forward, reverse, and neutral in a standard transmission assembly.

Referring again to FIGS. 1-6 in a next step, the converter 202 transforms the signals provided by the sensor 200 to analog signals. In a next step, the analog signals are transmitted to the diagnostic controller (not shown). Next, the diagnostic controller determines if an error exists. In a non-limiting example, the diagnostic controller can determine if an error exists by comparing the actual position to the desired position. If an error is found, the diagnostic controller can respond by providing a user notification regarding the error, sending a signal to power the motor until the desired position is achieved, and any other appropriate response.

Referring again to FIGS. 1 and 2, while the rotary actuator 10 is described above as having a short overall length L, advantageously the rotary actuator 10 is configured to provide significant operational characteristics considering the short overall length. In the illustrated embodiment, the rotary actuator 10 is configured to provide torque in a range of from about 300.0 pounds per inch to about 350 pounds per inch and a no load speed of 140 degrees per second using a maximum of 10.0 amperes at 14.4 volts. In addition, the rotary actuator 10 is configured to produce 150,000 shift cycles at a torque of 50.0 pounds per inch, 90,000 shift cycles at a torque of 130.0 pounds per inch and 50,000 shift cycles at stall. Advantageously, the significant operational characteristics are provided while operating in a submerged arrangement under 12.0 inches of sea water at a maximum pressure of 50.0 pounds per square inch. A non-limiting example of a possible shift cycle relating to a transmission includes the shift cycle of neutral to forward, forward to neutral, and neutral to reverse. However, it must be understood any shift cycle may be used, including shift cycles relating to other mechanism, structures, or devices apart from a transmission.

The principle and mode of operation of the electro-mechanical rotary actuator have been explained and illustrated in the illustrated embodiment. However, it must be appreciated that the electro-mechanical rotary actuator may be practiced otherwise than as specifically explained and illustrated without departing from its spirit or scope.

What is claimed is:

1. A rotary actuator comprising:
a plurality of housings;
a motor supported within one of the housings, the motor including a rotatable motor output shaft, the rotatable motor output shaft centered about a first longitudinal axis;
a gear package configured to engage the motor output shaft of the motor such that rotation of the motor output shaft results in rotation of portions of the gear package; and
an actuator output shaft configured to engage the gear package such that rotation of portions of the gear package results in rotation of the actuator output shaft, the actuator output shaft centered about a second longitudinal axis;
wherein the first longitudinal axis is offset from the second longitudinal axis.

2. The rotary actuator of claim 1, wherein the first longitudinal axis has a substantially parallel orientation to the second longitudinal axis.

3. The rotary actuator of claim 1, wherein a pinion gear is mounted to the motor output shaft and is configured to engage a cluster gear mounted to the actuator output shaft.

4. The rotary actuator of claim 1, wherein the rotary actuator is substantially waterproof when submerged in water having a depth of about 12.0 inches.

5. The rotary actuator of claim 1, wherein the rotary actuator provides torque in a range of from about 300.0 pounds per inch to about 350.0 pounds per inch.

6. The rotary actuator of claim 1, wherein the rotary actuator provides a no load speed of 140 degrees per second and uses a maximum of 10.0 amperes at 14.4 volts.

7. A rotary actuator comprising:
a plurality of housings;
a motor supported within the housings, the motor including a rotatable motor output shaft;
a gear package configured to engage the motor output shaft of the motor such that rotation of the motor output shaft results in rotation of portions of the gear package;
an actuator output shaft configured to engage the gear package such that rotation of portions of the gear package results in rotation of the actuator output shaft;
a feedback system including a feedback shaft, the feedback shaft extending in a direction opposite the actuator output shaft and is configured to rotate as the actuator output shaft rotates.

8. The rotary actuator of claim 7, wherein the feedback shaft is attached to the output shaft.

9. The rotary actuator of claim 7, wherein the feedback shaft and the output shaft have a common longitudinal axis.

10. The rotary actuator of claim 7, wherein the feedback shaft has a longitudinal axis and the motor output shaft has a different longitudinal axis that is offset from the longitudinal axis of the feedback shaft.

11. The rotary actuator of claim 10, wherein the longitudinal axis of the feedback shaft has a substantially parallel orientation to the longitudinal axis of the motor output shaft.

12. The rotary actuator of claim 7, wherein the rotary actuator is substantially waterproof when submerged in water having a depth of about 12.0 inches.

13. The rotary actuator of claim 7, wherein the rotary actuator provides torque in a range of from about 300.0 pounds per inch to about 350.0 pounds per inch.

14. A rotary actuator comprising:
a plurality of housings, the plurality of housing forming a length;
a motor supported within one of the housings, the motor including a rotatable motor output shaft;
a gear package configured to engage the motor output shaft of the motor such that rotation of the motor output shaft results in rotation of portions of the gear package;
an actuator output shaft configured to engage the gear package such that rotation of portions of the gear package results in rotation of the actuator output shaft;
wherein the length of the plurality of housing is in a range of from about 4.5 inches to about 7.5 inches.

15. The rotary actuator of claim 14, wherein the motor output shaft has a longitudinal axis that is offset from a longitudinal axis of the actuator output shaft.

16. The rotary actuator of claim 15, wherein the longitudinal axis of the feedback shaft has a substantially parallel orientation to the longitudinal axis of the motor output shaft.

17. The rotary actuator of claim 14, wherein the rotary actuator is substantially waterproof when submerged in water having a depth of about 12.0 inches.

18. The rotary actuator of claim 14, wherein the rotary actuator provides torque in a range of from about 300.0 pounds per inch to about 350.0 pounds per inch.

19. The rotary actuator of claim 14, wherein the rotary actuator provides a no load speed of 140 degrees per second and uses a maximum of 10.0 amperes at 14.4 volts.

20. The rotary actuator of claim 14, wherein the rotary actuator is configured to produce 150,000 shift cycles at a torque of 50.0 pounds per inch, 90,000 shift cycles at a torque of 130.0 pounds per inch and 50,000 shift cycles at stall.
